(19) United States
(12) Patent Application Publication
(10) Pub. No.: US 2022/0187733 A1
(43) Pub. Date: Jun. 16, 2022

(54) DETERMINATION OF STATUS OF LASER SCANNING DEVICE USING PHOTO DETECTOR

(71) Applicant: Hewlett-Packard Development Company, L.P., Spring, TX (US)

(72) Inventor: Suwhan Kim, Pangyo (KR)

(73) Assignee: Hewlett-Packard Development Company, L.P., Spring, TX (US)

(21) Appl. No.: 17/417,161

(22) PCT Filed: Jan. 17, 2020
(86) PCT No.: PCT/US2020/014030

§ 371 Date: Jun. 22, 2021

(30) Foreign Application Priority Data
Aug. 23, 2019 (KR) 10-2019-0103483

(51) Int. Cl. G03G 15/043

(52) U.S. Cl. CPC G03G 15/043

(57) ABSTRACT

An example method of operating an image forming apparatus includes setting an initial minimum voltage value of a laser light emitter at which a synchronization signal of a laser beam is detected by a photo detector, determining a first minimum voltage value of the laser light emitter at which the synchronization signal is detected by the photo detector in a non-image forming operation of the image forming apparatus, determining a state of a laser scanning device in the image forming apparatus based on a result of comparing the first minimum voltage value to the initial minimum voltage value, and outputting a result of the determining of the state of the laser scanning device.

### BACKGROUND

An image forming apparatus may form an image on a recording medium such as a paper sheet through an image forming process of charging, exposing, developing, transferring, and fixing. As an example, an image forming apparatus may supply toner to an electrostatic latent image formed on a photoconductor, form a visible toner image on the photoconductor, transfer the toner image to a recording medium, and fix the transferred toner image to the recording medium to print an image on the recording medium.

### BRIEF DESCRIPTION OF THE DRAWINGS

FIG. 1 is a diagram for describing a schematic structure and operation of an image forming apparatus, according to an example;

FIG. 2 is a diagram of a laser scanning device in an image forming apparatus, according to an example;

FIG. 3 is a flowchart of a method of operating an image forming apparatus, according to an example;

FIG. 4 is a diagram for describing a process of determining a state of a laser scanning device, according to an example;

FIG. 5 is a diagram for describing a process of determining a state of a laser scanning device based on a result of comparing a minimum voltage value of a laser light emitter at which a synchronization signal is detected by a photo detector to an initial value of the minimum voltage value, according to an example;

FIG. 6 is a diagram for describing a determination result displayed on a user interface device of an image forming apparatus, according to an example;

FIG. 7 is a diagram for describing a method of operating an image forming apparatus in a case of continuing to use the image forming apparatus having a defect in a laser scanning device, according to an example;

FIG. 8 is a diagram for describing a process of determining a state of a laser scanning device, according to an example;

FIG. 9 is a diagram for describing a process of determining a state of a laser scanning device based on a result of comparing a minimum voltage value of a laser light emitter at which a synchronization signal is detected by a photo detector with a minimum control voltage within a control voltage range and an initial value of the minimum voltage value, according to an example; and

FIG. 10 is a block diagram illustrating an image forming apparatus according to an example.

### DETAILED DESCRIPTION OF EXAMPLES

The term “image forming apparatus” may refer to any type of apparatus capable of performing an image forming operation, such as a printer, a copier, a scanner, a fax machine, a multi-function printer (MFP), or a display apparatus. Also, the term “print data” may refer to data converted into a printable format in a printer. On the other hand, if the printer supports direct printing, the file itself may become the print data. Also, the term “scan file” may refer to a file generated by scanning an image by a scanner.

Hereinafter, examples of the present disclosure will be described with reference to the accompanying drawings so that those of ordinary skill in the art may easily implement the examples. However, the present disclosure may be implemented in various different forms and should not be construed as being limited to the examples described herein.

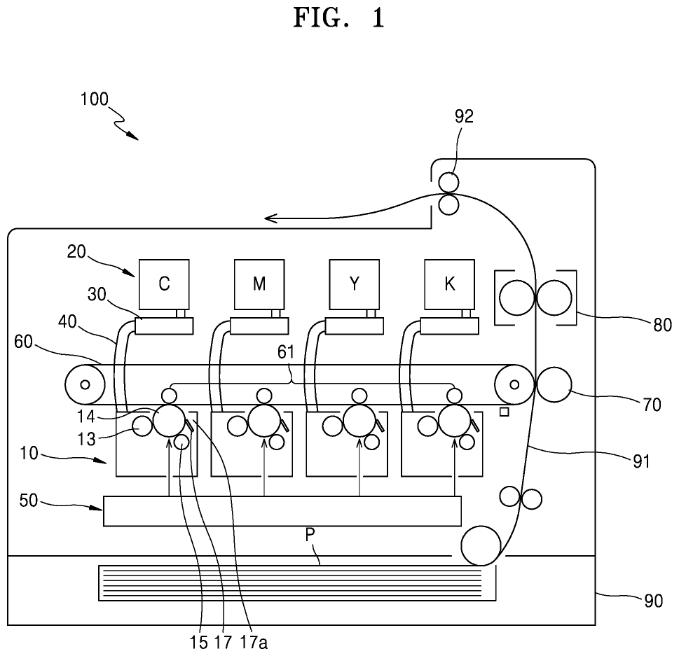

FIG. 1 is a diagram for describing a schematic structure and operation of an image forming apparatus, according to an example.

Referring to FIG. 1, an image forming apparatus 100 may include a plurality of developing devices 10, a plurality of developer cartridges 20, a developer supply unit 30, an exposure device 50, a transfer unit, and a fixing unit 80.

The plurality of developing devices 10 may form toner images of cyan (C), magenta (M), yellow (Y), and black (K) colors. The plurality of developer cartridges 20 may respectively contain developers of cyan, magenta, yellow, and black colors to be supplied to the plurality of developing devices 10. The developer supply unit 30 may supply the developer to the developing device 10 through a supply pipeline 40.

The developing device 10 may include a photoconductor 14 on the surface of which an electrostatic latent image may be formed and a developing roller 13 for supplying a developer to an electrostatic latent image by a developing bias voltage to develop the electrostatic latent image into a visible toner image. A photosensitive drum may be an example of the photoconductor 14, on the surface of which an electrostatic latent image is formed, and may be an organic photo conductor (OPC) including a conductive metal pipe and a photosensitive layer formed on an outer circumference thereof. A charging roller 15 may be an example of a charger for charging the photoconductor 14 to have a uniform surface potential.

The developing device 10 may further include, for example, a charging roller cleaner (not illustrated) for removing impurities such as dust or developer attached to the charging roller 15, a cleaning member 17 for removing developer remaining on the surface of the photoconductor 14 after an intermediate transfer process, and a regulating member for regulating the amount of developer supplied to a developing region where the photoconductor 14 and the developing roller 13 face each other. Waste developer may be contained in a waste developer container 17a.

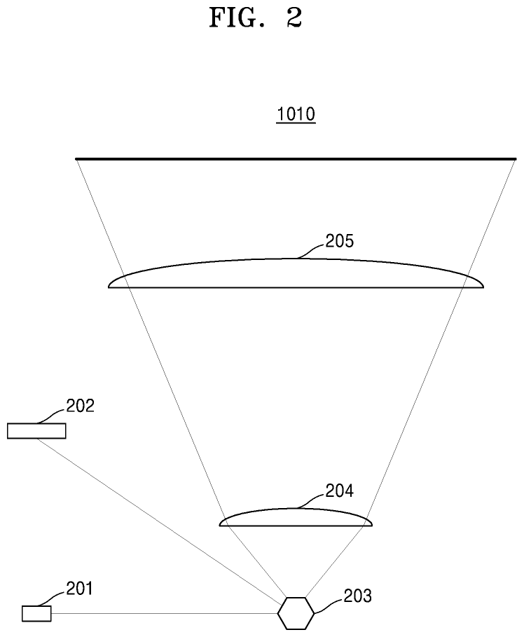

The exposure device 50 may irradiate light, which is modulated corresponding to image information, to the photoconductor 14 to form an electrostatic latent image on the photoconductor 14 and may include, for example, a laser scanning unit (LSU) using a laser light emitter as a light source or a light emitting diode (LED) exposure device using an LED as a light source. Here, the exposure device 50 may correspond to a laser scanning device described with reference to FIGS. 2 to 10.

The transfer unit may transfer the toner image formed on the photoconductor 14 to a recording medium P. As an example, the transfer unit may include an intermediate transfer member 60, an intermediate transfer roller 61, and a transfer roller 70.

The developed toner images may be sequentially intermediately-transferred to the intermediate transfer member 60. The recording medium P loaded on a paper feed unit 90 may be transferred along a paper feed path 91 and transferred between the transfer roller 70 and the intermediate transfer member 60. The toner image intermediately-transferred onto the intermediate transfer member 60 by a transfer bias voltage applied to the transfer roller 70 may be transferred to the recording medium P. When the recording medium P passes through the fixing unit 80, the toner image may be fixed to the recording medium P by heat and pressure. Upon completion of the fixing, the recording medium P may be discharged by a discharge roller 92.

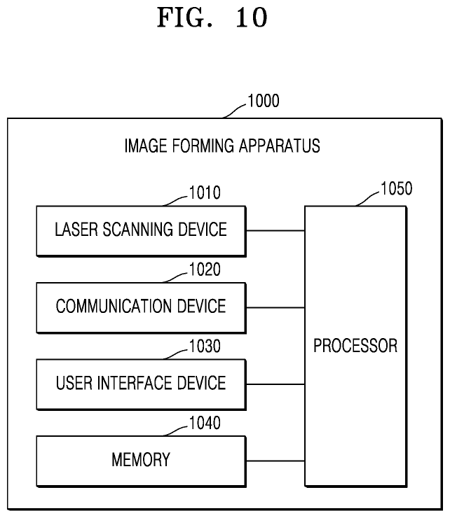

FIGS. 2 to 10 illustrate a method of operating an image forming apparatus 1000 that determines a state of a laser scanning device based on an initial voltage value and a minimum voltage value applied to a laser light emitter when a synchronization signal is detected by a photo detector. The image forming apparatus 100 illustrated in FIG. 1 may correspond to the image forming apparatus 1000 illustrated in FIG. 10. Also, an example method of operating the image forming apparatus 1000 described with reference to FIGS. 2 to 9 may correspond to a method of operating each component of the image forming apparatus 1000 described with reference to FIG. 10.

FIG. 2 is a diagram for describing a laser scanning device in an image forming apparatus, according to an example.

Referring to FIG. 2, a laser scanning device 1010 in the image forming apparatus 1000 may include a laser light emitter 201, a photo detector 202, a polygon mirror 203, and optical lenses 204 and 205. However, not all of the illustrated components are necessary components. The laser scanning device 1010 may be implemented by more components than the illustrated components or may be implemented by fewer components than the illustrated components. The above components will be described below.

The laser light emitter 201 may irradiate a laser beam used in an image forming operation. For example, the laser light emitter 201 may be a laser diode (LD). The photo detector 202 may detect a synchronization signal of the laser beam, for example when the laser beam is used in a main scanning direction. In an example, the photo detector 202 may be a photo diode (PD) sensor. In an example, the main scanning direction may refer to a scanning direction of the image forming operation. The photo detector 202 may receive the laser beam irradiated from the laser light emitter 201 and output the synchronization signal when the light amount of the received laser beam is greater than or equal to a certain light amount. Here, the output synchronization signal may be a signal representing an ON state. When the light amount of the laser beam received by the photo detector 202 is less than the certain light amount, no signal may be output from the photo detector 202. Also, the photo detector 202 may output a signal representing an OFF state. The polygon mirror 203 may scan the laser beam irradiated from the laser light emitter 201. The optical lenses 204 and 205 may form an image by transmitting the laser beam.

A processor in the image forming apparatus 1000 may control the operations of the laser light emitter 201 and the polygon mirror 203. The processor in the image forming apparatus 1000 may control the image forming apparatus 1000 to perform a normal image forming operation when the synchronization signal is received from the photo detector 202.

When a cumulative rotation count of a polygon mirror in the laser scanning device 1010 increases, dust or the like may be attached to a mirror surface thereof and thus contamination may occur thereon. When contamination occurs on the mirror surface thereof, the amount of light from the laser beam received by the photo detector 202 may decrease. When the amount of light from the laser beam decreases, the synchronization signal may not be detected by the photo detector 202 and the operation state of the image forming apparatus 1000 may become a disabled state. Also, dust or the like may be attached to the surface of the photo detector 202 and the lens on the path through which the laser beam passes and thus contamination may occur thereon. When contamination occurs on the surface of the photo detector 202 and the lens, the synchronization signal may not be detected by the photo detector 202.

Thus, the image forming apparatus 1000 may determine the state of the laser scanning device 1010 before a certain image forming operation and perform an operation according to the determination result thereof.

As an example, when the photo detector 202 corresponding to the laser light emitter 201 is provided, the processor in the image forming apparatus 1000 may drive the laser light emitter 201 by a digital-to-analog conversion (DAC) voltage and set a minimum DAC voltage value, at which the synchronization signal is detected by the photo detector 202, as an initial value. Thereafter, the image forming apparatus 1000 may periodically monitor a minimum DAC voltage value at which the synchronization signal is detected by the photo detector 202 in a non-image forming operation. The non-image forming operation may represent a case in which the image forming apparatus 1000 is powered on after a certain image forming operation is completed. As a result of the monitoring, when a difference value between the minimum DAC voltage value and the initial value is greater than or equal to a certain threshold value, the image forming apparatus 1000 may determine that the laser scanning device 1010 has a defect. Here, “determination” may mean decision, check, analysis, verification, diagnosis, interpretation, prediction, estimation, or the like. The image forming apparatus 1000 may display the determination result thereof on a user interface device of the image forming apparatus 1000.

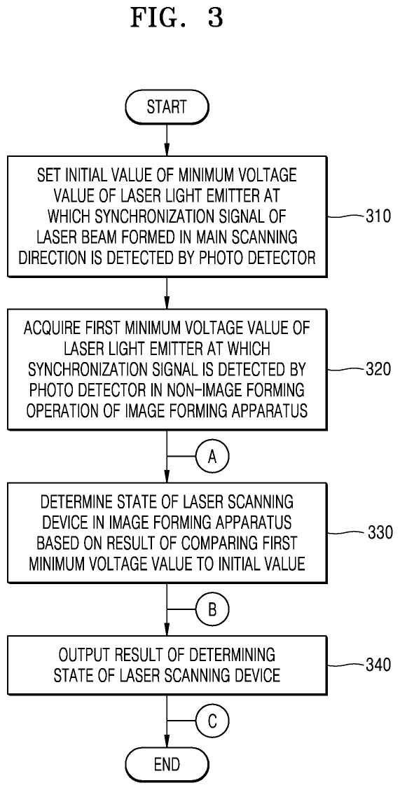

FIGS. 3 to 10 illustrate an example method of operating an image forming apparatus that determines a state of a laser scanning device and provides a determination result thereof.

FIG. 3 is a flowchart of a method of operating an image forming apparatus, according to an example.

Referring to FIG. 3, the image forming apparatus 1000 may set an initial value of a minimum voltage value of a laser light emitter (e.g., a laser diode (LD)) at which a synchronization signal of a laser beam is detected by a photo detector (e.g., a PD sensor) in operation 310. Here, the synchronization signal may be a horizontal synchronization signal corresponding to the main scanning direction.

In operation 320, the image forming apparatus 1000 may determine a first minimum voltage value of the laser light emitter at which the synchronization signal is detected by the photo detector in a non-image forming operation of the image forming apparatus 1000. For example, when a certain time elapses, when the image forming apparatus 1000 is powered on, or when a certain image forming operation is completed in the image forming apparatus 1000, the image forming apparatus 1000 may determine the first minimum voltage value that has to be applied to the laser light emitter to the minimum when the synchronization signal is detected by the photo detector.

For example, a processor of the image forming apparatus 1000 may apply a minimum voltage value corresponding to the initial value to the laser light emitter. The laser light emitter may irradiate a laser beam corresponding to the applied minimum voltage value. The processor of the image forming apparatus 1000 may determine whether the synchronization signal of the laser beam is detected by the photo detector. When the synchronization signal is not detected, the processor of the image forming apparatus 1000 may determine a voltage value of the laser light emitter at which the synchronization signal starts to be detected by the photo detector, while adjusting a voltage value applied to the laser light emitter. The processor of the image forming apparatus 1000 may determine the voltage value of the laser light emitter at which the synchronization signal starts to be detected by the photo detector as the first minimum voltage value.

In operation 330, the image forming apparatus 1000 may determine a state of the laser scanning device in the image forming apparatus 1000 based on a result of comparing the first minimum voltage value to the initial value. Here, “determination” may mean decision, check, analysis, verification, diagnosis, interpretation, prediction, estimation, or the like.

For example, the image forming apparatus 1000 may determine a difference value between the first minimum voltage value and the initial value. When the difference value is greater than or equal to a certain threshold value, the image forming apparatus 1000 may determine that the laser scanning device has a defect. Here, the certain threshold value may be a value used as a reference for determining whether the laser scanning device has a defect.

Also, when the difference value is less than the certain threshold value, the image forming apparatus 1000 may periodically monitor a minimum voltage value of the laser light emitter at which the synchronization signal is detected by the photo detector in a non-image forming operation of the image forming apparatus 1000.

Also, when the image forming apparatus 1000 is a color image forming apparatus, the image forming apparatus 1000 may determine a state of the laser scanning device in the image forming apparatus 1000 based on a result of comparing a minimum voltage value to an initial value for a laser light emitter of each of a plurality of colors.

In operation 340, the image forming apparatus 1000 may output a result of determining the state of the laser scanning device.

For example, the image forming apparatus 1000 may display the result of determining the state of the laser scanning device through the user interface device of the image forming apparatus 1000. As an example, when the state of the laser scanning device is determined to be a defective state, the image forming apparatus 1000 may display, on the user interface device, a message indicating that the laser scanning device needs to be replaced or repaired. On the other hand, when the state of the laser scanning device is determined to be a normal state, the image forming apparatus 1000 may display a message for guiding the progress of a certain image forming operation.

As another example, the image forming apparatus 1000 may transmit the result of determining the state of the laser scanning device to a server managing the image forming apparatus 1000. As an example, when the state of the laser scanning device is determined to be a defective state, the image forming apparatus 1000 may transmit a message indicating that the laser scanning device needs to be replaced or repaired, through a communication device to a server managing the image forming apparatus 1000.

The image forming apparatus 1000 may increase user convenience and prevent the loss of print data by determining the state of the laser scanning device before a certain image forming operation and performing an operation according to the determination result thereof. Also, because the determination information about the laser scanning device is transmitted to the server, the state of the image forming apparatus 1000 may be determined even when a service manager does not directly visit the image forming apparatus 1000.

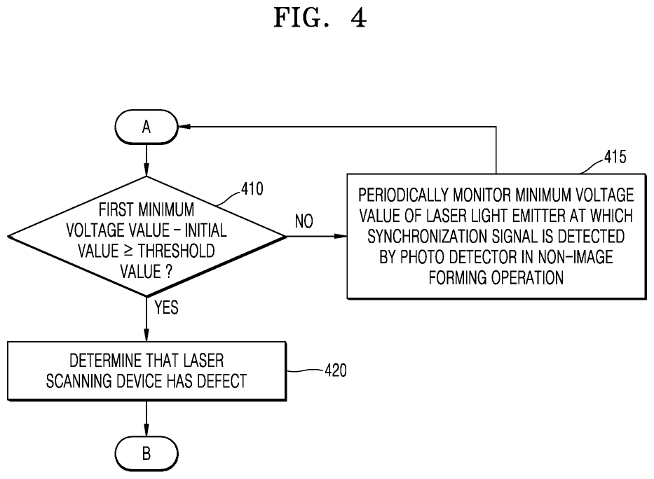

FIG. 4 is a diagram for describing a process of determining a state of a laser scanning device, according to an example.

Referring to FIG. 4, the image forming apparatus 1000 may determine a difference value between the first minimum voltage value and the initial value in operation 410. The image forming apparatus 1000 may determine whether the difference value is greater than or equal to a threshold value used as a reference for determining whether the laser scanning device has a defect.

For example, when the difference value is less than the threshold value, the image forming apparatus 1000 may determine that the laser scanning device has no defect in operation 415. In that case, the image forming apparatus 1000 may also periodically monitor a minimum voltage value of the laser light emitter at which the synchronization signal is detected by the photo detector in a non-image forming operation of the image forming apparatus 1000.

Alternatively, when the difference value is greater than or equal to the threshold value, the image forming apparatus 1000 may determine that the laser scanning device has a defect in operation 420.

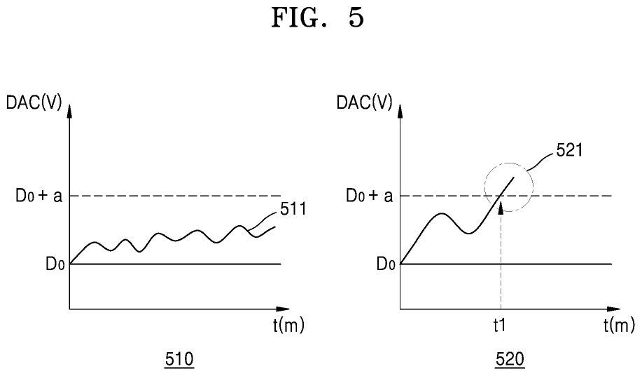

FIG. 5 is a diagram for describing a process of determining a state of a laser scanning device based on a result of comparing a minimum voltage value of a laser light emitter at which a synchronization signal is detected by a photo detector to an initial value of the minimum voltage value, according to an example.

Referring to FIG. 5, the image forming apparatus 1000 may set an initial value D₀ of a minimum voltage value applied to the laser light emitter such that the synchronization signal of the laser beam may be detected by the photo detector. Also, the image forming apparatus 1000 may set a certain threshold value “a” above the initial value D₀ as a reference for determining whether the laser scanning device has a defect.

The image forming apparatus 1000 may determine a minimum voltage value of the laser light emitter at which the synchronization signal is detected by the photo detector in a non-image forming operation. When the determined minimum voltage value is less than the sum (D₀+a) of the initial value Do and the threshold value “a”, the image forming apparatus 1000 may determine that the laser scanning device has no defect.

As illustrated in a graph 510 of FIG. 5, a curve 511 represents a minimum voltage value of the laser light emitter determined in a non-image forming operation of the image forming apparatus 1000. In this case, because the minimum voltage value is less than the sum (D₀+a) of the initial value D₀ and the threshold value “a”, the image forming apparatus 1000 may determine that the laser scanning device has no defect.

On the other hand, as illustrated in a graph 520 of FIG. 5, because a minimum voltage value of the laser light emitter in a region 521 determined after a time t1 is greater than the sum (D₀+a) of the initial value D₀ and the threshold value “a”, the image forming apparatus 1000 may determine that the laser scanning device has a defect.

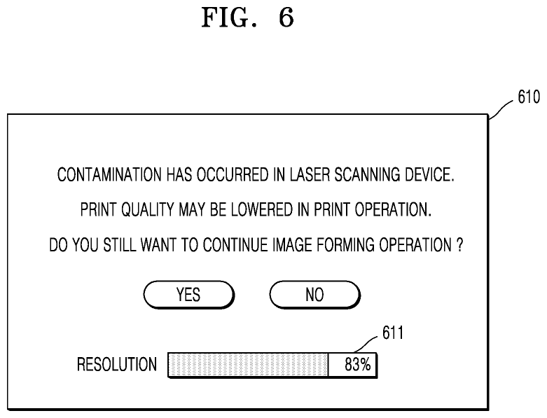

FIG. 6 is a diagram for describing a determination result displayed on a user interface device of an image forming apparatus, according to an example.

Referring to FIG. 6, the image forming apparatus 1000 may display the result of determining the state of the laser scanning device on a user interface device. For example, when it is determined that there is a defect in the state of the laser scanning device, the image forming apparatus 1000 may display a determination result indicating the defect of the laser scanning device.

As illustrated in an image 610 of FIG. 6, when it is determined that there is a defect in the state of the laser scanning device, the image forming apparatus 1000 may display information indicating that contamination has occurred in the laser scanning device and information indicating that the print quality may be lowered in a print operation.

Also, because the image forming apparatus 1000 may perform an image forming operation even when the laser scanning device has a defect, the image forming apparatus 1000 may display a message for inquiring whether to continue to perform an image forming operation. Upon receiving a command to continue to perform an image forming operation, the image forming apparatus 1000 may perform a certain image forming operation according to a certain image forming operation command.

Also, when continuing to perform an image forming operation, the image forming apparatus 1000 may display resolution information 611 about the result output by the image forming operation. Because the resolution information 611 is displayed in advance, the user may determine whether to continue to perform a certain image forming operation.

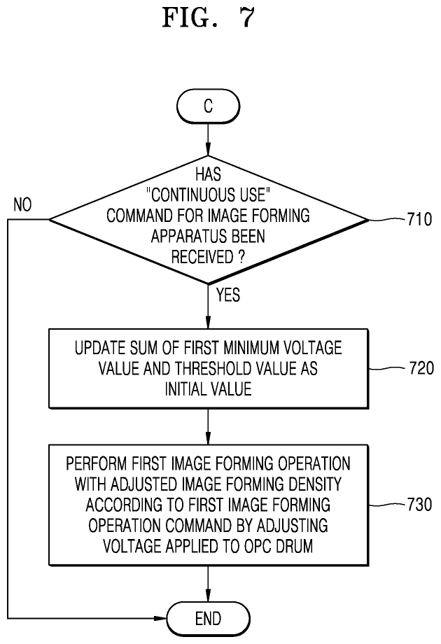

FIG. 7 is a diagram for describing a method of operating an image forming apparatus in a case of continuing to use the image forming apparatus having a defect in a laser scanning device, according to an example.

Referring to FIG. 7, the image forming apparatus 1000 may determine whether a “Continuous Use” command for the image forming apparatus 1000 is received in operation 710. When the “Continuous Use” command for the image forming apparatus 1000 is not received, the image forming apparatus 1000 may not perform a certain image forming operation. On the other hand, when the “Continuous Use” command for the image forming apparatus 1000 is received, the image forming apparatus 1000 may control components in the image forming apparatus 1000 to perform a certain image forming operation in the image forming apparatus 1000, in operations 720 and 730.

In operation 720, the image forming apparatus 1000 may update the sum of the first minimum voltage value and the threshold value as the initial value. Here, the threshold value may be a certain voltage value above the initial value used as a reference for determining whether the laser scanning device has a defect.

In operation 730, the image forming apparatus 1000 may perform a first image forming operation with an adjusted image forming density by adjusting a voltage applied to an OPC drum in the image forming apparatus 1000 according to a first image forming operation command. For example, the image forming apparatus 1000 may adjust the image forming density by adjusting at least one of a voltage for moving charged toner to the OPC drum or a voltage for charging the toner by the OPC drum. When the image forming density is adjusted, a clearer image may be generated than before the image forming density is adjusted. Thus, even after the initial defect determination about the laser scanning device, the image forming apparatus 1000 may perform an image forming operation without image quality degradation until replacement of the laser scanning device.

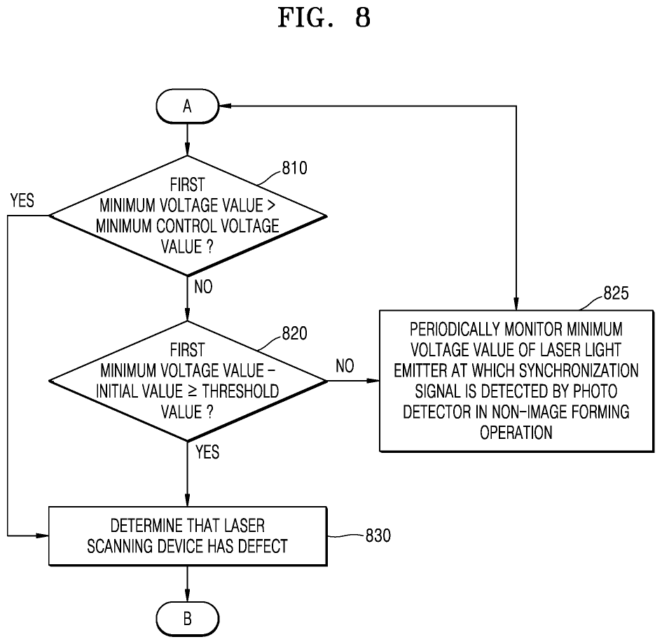

FIG. 8 is a diagram for describing a process of determining a state of a laser scanning device, according to an example.

Referring to FIG. 8, the image forming apparatus 1000 may compare a first minimum voltage value to a minimum control voltage value in operation 810. Here, the minimum control voltage value may be a minimum voltage value within a control voltage range of the laser light emitter set to form a certain image in the image forming apparatus 1000.

For example, as a result of the comparison between the first minimum voltage value and the minimum control voltage value, when the first minimum voltage value is greater than the minimum control voltage value, the image forming apparatus 1000 may determine that the laser scanning device has a defect in operation 830.

As a result of the comparison between the first minimum voltage value and the minimum control voltage value, when the first minimum voltage value is not greater than the minimum control voltage value, the image forming apparatus 1000 may determine whether the difference value between the first minimum voltage value and the initial value is greater than or equal to a threshold value used as a reference for determining whether the laser scanning device has a defect in operation 820.

When the difference value between the first minimum voltage value and the initial value is greater than or equal to the threshold value, the image forming apparatus 1000 may determine that the laser scanning device has a defect in operation 830.

Alternatively, when the difference value between the first minimum voltage value and the initial value is less than the threshold value, the image forming apparatus 1000 may periodically monitor a minimum voltage value of the laser light emitter at which the synchronization signal is detected by the photo detector in a non-image forming operation, in operation 825. That is, the image forming apparatus 1000 may determine the state of the laser scanning device by repeatedly performing operations 810 to 825.

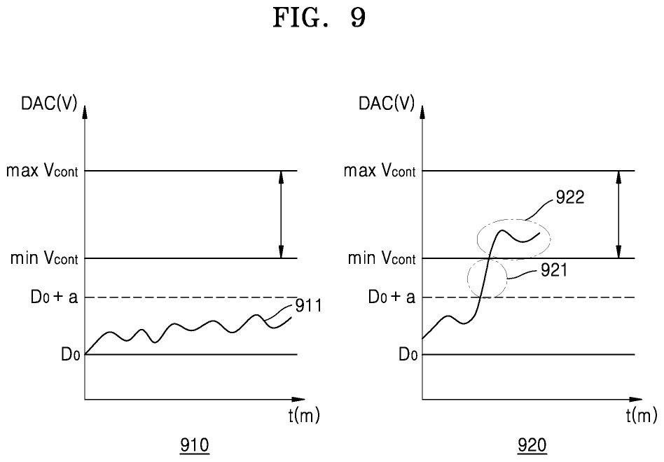

FIG. 9 is a diagram for describing a process of determining a state of a laser scanning device based on a result of comparing a minimum voltage value of a laser light emitter at which a synchronization signal is detected by a photo detector with a minimum control voltage within a control voltage range and an initial value of the minimum voltage value, according to an example.

Referring to FIG. 9, the image forming apparatus 1000 may set an initial value D₀ of a minimum voltage value applied to the laser light emitter such that the synchronization signal of the laser beam may be detected by the photo detector. Also, the image forming apparatus 1000 may set a certain threshold value “a” above the initial value D₀ as a reference for determining whether the laser scanning device has a defect.

Also, the image forming apparatus 1000 may set the range of a control voltage V_{CONT} applied to the laser light emitter to form a certain image, with a margin equal to or greater than a certain voltage value with respect to the initial value D₀. Here, the light amount of the laser beam irradiated from the laser light emitter may be adjusted by adjusting the control voltage V_{CONT}.

As illustrated in a graph 910, the range of the control voltage V_{CONT} may be set to min V_{CONT}≤V_{CONT}≤max V_{CONT}. A minimum control voltage value min V_{CONT} may be a voltage applied to the laser light emitter when a minimum amount of light is irradiated from the laser light emitter to form a certain image in the image forming apparatus 1000.

When a first minimum voltage value is greater than the minimum control voltage value min V_{CONT}, a synchronization signal detection error may occur in the photo detector. Referring to the graph 910, a minimum voltage value 911 illustrated in the graph 910 is less than the minimum control voltage value min V_{CONT}. Also, because the minimum voltage value 911 is less than the sum (D₀+a) of the initial value D₀ and the threshold value “a”, the image forming apparatus 1000 may determine that the laser scanning device has no defect.

As illustrated in a graph 920, a minimum voltage value of the laser light emitter in a region 921 is less than the minimum control voltage value min V_{CONT}. However, because the minimum control voltage value min V_{CONT} in the region 921 is greater than the sum (D₀+a) of the initial value D₀ and the threshold value “a”, the image forming apparatus 1000 may determine that the laser scanning device has a defect. In this case, the image forming apparatus 1000 may display a message for inquiring the user whether to continue to use the image forming apparatus 1000. In the case of continuing to use the image forming apparatus 1000 including the laser scanning device having a defect, the image forming apparatus 1000 may perform an operation of the image forming apparatus 1000 as described with reference to FIG. 7.

Also, because the minimum voltage value of the laser light emitter in a region 922 is greater than the minimum control voltage value min V_{CONT}, the image forming apparatus 1000 may determine that the laser scanning device has a defect. Likewise, the image forming apparatus 1000 may display a message for inquiring the user whether to continue to use the image forming apparatus 1000. In the case of continuing to use the image forming apparatus 1000 including the laser scanning device having a defect, the image forming apparatus 1000 may perform an operation of the image forming apparatus 1000 as described with reference to FIG. 7.

FIG. 10 is a block diagram illustrating an image forming apparatus according to an example.

Referring to FIG. 10, the image forming apparatus 1000 may include a laser scanning device 1010, a communication device 1020, a user interface device 1030, a memory 1040, and a processor 1050. However, not all of the illustrated components are necessary components. The image forming apparatus 1000 may be implemented by more components than the illustrated components or may be implemented by fewer components than the illustrated components. The above components will be described below. The image forming apparatus 1000 of FIG. 10 may correspond to the image forming apparatus 100 of FIG. 1.

The laser scanning device 1010 may include a laser light emitter and a photo detector. The laser light emitter may irradiate a laser beam used in an image forming operation. The photo detector may detect a synchronization signal of the laser beam formed in a main scanning direction. For example, the photo detector may be a PD sensor. The photo detector may receive the laser beam irradiated from the laser light emitter and output the synchronization signal when the light amount of the received laser beam is greater than or equal to a certain light amount.

The communication device 1020 may communicate with an external apparatus. As an example, the communication device 1020 may be connected to a network by wire or wirelessly to communicate with an external apparatus. Here, the external apparatus may include an electronic apparatus, a server, a smartphone, a tablet, a personal computer (PC), a camera, a wearable device, or the like. The communication device 1020 may include a communication module that supports one of various wired/wireless communication methods. For example, the communication module may be in the form of a chipset or may be a sticker/barcode including information necessary for communication (e.g., a sticker including a Near Field Communication (NFC) tag). Also, the communication module may include a short-range communication module or a wired communication module.

The communication device 1020 may support, for example, at least one of wireless Local Area Network (LAN), Wireless Fidelity (Wi-Fi), Wi-Fi Direct, Bluetooth, Universal Serial Bus (USB), wired LAN, Near Field Communication (NFC), or the like.

The user interface device 1030 may include an input unit for receiving an input for controlling an operation of the image forming apparatus 1000 from the user and an output unit for displaying information such as the result of the operation of the image forming apparatus 1000 or the state of the image forming apparatus 1000. For example, the user interface device 1030 may include an operation panel for receiving a user input and/or a display panel for displaying a screen.

As an example, the input unit may include devices capable of receiving various types of user input, such as a keyboard, a physical button, a touchscreen, a camera, a microphone, or the like. Also, for example, the output unit may include a display panel, a speaker, or the like. However, the present disclosure is not limited thereto, and the user interface device 1030 may include any devices supporting various input/outputs.

The memory 1040 may store programs, data, or files related to the image forming apparatus 1000. The processor 1050 may execute a program stored in the memory 1040, read data or files stored in the memory 1040, or store a new file in the memory 1040. The memory 1040 may store program commands, data files, data structures, and the like alone or in combination. The memory 1040 may store instructions executable by the processor 1050. For example, the memory 1040 may store a program that is related to a method of operating the image forming apparatus 1000 to determine the state of the laser scanning device 1010 based on an initial voltage value and a minimum voltage value applied to the laser light emitter when a synchronization signal is detected by the photo detector.

The processor 1050 may control an overall operation of the image forming apparatus 1000 and may include at least one processor such as a central processing unit (CPU). The processor 1050 may include at least one specialized processor corresponding to each function or may be a processor in the form of a single integral unit.

The processor 1050 may set an initial value of a minimum voltage value of the laser light emitter at which a synchronization signal of a laser beam formed in a main scanning direction is detected by the photo detector. The processor 1050 may store the set initial value in the memory 1040.

The processor 1050 may determine a first minimum voltage value of the laser light emitter at which the synchronization signal is detected by the photo detector in a non-image forming operation of the image forming apparatus 1000.

For example, the processor 1050 may apply a minimum voltage value corresponding to the initial value to the laser light emitter. The laser light emitter may irradiate a laser beam corresponding to the applied minimum voltage value. The processor 1050 may determine whether the synchronization signal of the laser beam is detected by the photo detector. When the synchronization signal is not detected, the processor 1050 may determine a voltage value of the laser light emitter at which the synchronization signal starts to be detected by the photo detector, while adjusting a voltage value applied to the laser light emitter. The processor 1050 may determine the voltage value of the laser light emitter at which the synchronization signal starts to be detected by the photo detector, as the first minimum voltage value.

The processor 1050 may determine a state of the laser scanning device 1010 in the image forming apparatus 1000 based on a result of comparing the first minimum voltage value to the initial value.

For example, the processor 1050 may determine a difference value between the first minimum voltage value and the initial value. When the difference value is greater than or equal to a certain threshold value, the processor 1050 may determine that the laser scanning device 1010 has a defect. Here, the certain threshold value may be a value used as a reference for determining whether the laser scanning device 1010 has a defect.

Also, when the difference value is less than the certain threshold value, the processor 1050 may periodically monitor a minimum voltage value of the laser light emitter at which the synchronization signal is detected by the photo detector in a non-image forming operation of the image forming apparatus 1000.

For example, the processor 1050 may compare the first minimum voltage value to a minimum control voltage value. Here, the minimum control voltage value may be a minimum voltage value within a control voltage range of the laser light emitter set to form a certain image in the image forming apparatus 1000.

As a result of the comparison between the first minimum voltage value and the minimum control voltage value, when the first minimum voltage value is greater than the minimum control voltage value, the processor 1050 may determine that the laser scanning device 1010 has a defect.

As a result of the comparison between the first minimum voltage value and the minimum control voltage value, when the first minimum voltage value is not greater than the minimum control voltage value, the processor 1050 may determine whether the difference value between the first minimum voltage value and the initial value is greater than or equal to a threshold value used as a reference for determining whether the laser scanning device 1010 has a defect. For example, when the difference value between the first minimum voltage value and the initial value is greater than or equal to the threshold value, the processor 1050 may determine that the laser scanning device 1010 has a defect. On the other hand, when the difference value between the first minimum voltage value and the initial value is less than the threshold value, the processor 1050 may periodically monitor a minimum voltage value of the laser light emitter at which the synchronization signal is detected by the photo detector in a non-image forming operation. That is, the image forming apparatus 1000 may determine a state of the laser scanning device 1010 based on the relationship between the periodically-determined minimum voltage value and the minimum control voltage value and the relationship between the minimum voltage value and the initial value.

Also, when the image forming apparatus 1000 is a color image forming apparatus, the processor 1050 may determine a state of the laser scanning device 1010 in the image forming apparatus 1000 based on a result of comparing a minimum voltage value to an initial value for a laser light emitter of each of a plurality of colors.

The processor 1050 may output the result of determining the state of the laser scanning device 1010.

For example, the processor 1050 may display the result of determining the state of the laser scanning device 1010 on the user interface device 1030. As an example, when the state of the laser scanning device 1010 is determined to be a defective state, the user interface device 1030 may display information indicating that contamination has occurred in the laser scanning device 1010 and information indicating that the print quality may be lowered in a print operation.

As another example, the processor 1050 may transmit the result of determining the state of the laser scanning device 1010, through the communication device 1020 to a server managing the image forming apparatus 1000.

Because the image forming apparatus 1000 may perform an image forming operation even when the laser scanning device 1010 has a defect, the user interface device 1030 may display a message for inquiring whether to continue to perform an image forming operation.

The processor 1050 may determine whether a “Continuous Use” command for the image forming apparatus 1000 is received. When the “Continuous Use” command for the image forming apparatus 1000 is not received, the processor 1050 may not perform a certain image forming operation. On the other hand, when the “Continuous Use” command for the image forming apparatus 1000 is received, the processor 1050 may control the components in the image forming apparatus 1000 such that a certain image forming operation may be performed in the image forming apparatus 1000.

For example, the processor 1050 may update the sum of the first minimum voltage value and the threshold value as the initial value. Here, the threshold value may be a certain voltage value used as a reference for determining whether the laser scanning device 1010 has a defect, from the initial value.

Also, according to a first image forming operation command, the processor 1050 may perform a first image forming operation with an adjusted image forming density by adjusting a voltage applied to an OPC drum in the image forming apparatus 1000.

The above method of operating the image forming apparatuses 100 and 1000 may be implemented in the form of a computer-readable storage medium storing instructions or data executable by a computer or a processor. It may be written as a program executable in a computer and may be implemented in a general-purpose digital computer that operates the program by using a computer-readable storage medium. The computer-readable storage medium may be Read-Only Memory (ROM), Random-Access Memory (RAM), flash memory, Compact Disk Read-Only Memory (CD-ROM), Compact Disk Recordable (CD-R), CD+R, Compact Disk Rewritable (CD-RW), CD+RW, Digital Versatile Disk Read-Only Memory (DVD-ROM), Digital Versatile Disk Recordable (DVD-R), DVD+R, Digital Versatile Disk Rewritable (DVD-RW), DVD+RW, Digital Versatile Disk Random-Access Memory (DVD-RAM), Blu-ray Disk Read-Only Memory (BD-ROM), Blu-ray Disk Recordable (BD-R), Blu-ray Disk Recordable Low to High (BD-R LTH), Blu-ray Disk Recordable Erasable (BD-RE), magnetic tapes, floppy disks, magneto-optical data storages, optical data storages, hard disks, Solid-State Disk (SSD), or any device that may store instructions or software, related data, data files, and data structures and may provide instructions or software, related data, data files, and data structures to a processor or computer to enable the processor or computer to execute instructions.

While the present disclosure has been described with reference to the drawings and particular examples, those of ordinary skill in the art may make various changes and modifications therein without departing from the spirit and scope of the disclosure. For example, the described techniques may be performed in a different order than the described method, and/or the described components such as systems, structures, devices, and circuits may be united or combined in a different form than the described method or may be replaced or substituted by other components or equivalents thereof.

It should be understood that examples described herein should be considered in a descriptive sense only and not for purposes of limitation. Descriptions of features or aspects within each example should typically be considered as available for other similar features or aspects in other examples. While one or more examples have been described with reference to the figures, it will be understood by those of ordinary skill in the art that various changes in form and details may be made therein without departing from the spirit and scope as defined by the following claims.

What is claimed is:

1. A method of operating an image forming apparatus, the method comprising:
setting an initial minimum voltage value of a laser light emitter at which a synchronization signal of a laser beam is detected by a photo detector;
determining a first minimum voltage value of the laser light emitter at which the synchronization signal is detected by the photo detector in a non-image forming operation of the image forming apparatus;
determining a state of a laser scanning device in the image forming apparatus based on a result of comparing the first minimum voltage value to the initial minimum voltage value; and
outputting a result of the determining of the state of the laser scanning device.

2. The method of claim 1, wherein the determining of the state of the laser scanning device in the image forming apparatus based on the result of comparing the first minimum voltage value to the initial minimum voltage value comprises:
determining a difference value between the first minimum voltage value and the initial minimum voltage value; and
determining that the laser scanning device has a defect when the difference value is greater than or equal to a threshold value.

3. The method of claim 2, further comprising periodically monitoring a minimum voltage value of the laser light emitter at which the synchronization signal is detected by the photo detector in the non-image forming operation of the image forming apparatus when the difference value is less than the threshold value.

4. The method of claim 1, wherein the outputting of the result of the determining of the state of the laser scanning device comprises at least one of:
displaying the result of the determining of the state of the laser scanning device on a user interface device of the image forming apparatus; or
transmitting the result of the determining of the state of the laser scanning device to a server managing the image forming apparatus.

5. The method of claim 2, further comprising:
receiving a user input to continue using the image forming apparatus when it is determined that the laser scanning device has the defect;
updating the initial minimum voltage value as a sum of the first minimum voltage value and the threshold value; and
performing a first image forming operation with an adjusted image forming density according to a first image forming operation command for the image forming apparatus by adjusting a voltage applied to an organic photo conductor (OPC) drum.

6. The method of claim 5, further comprising periodically monitoring a minimum voltage value of the laser light emitter at which the synchronization signal is detected by the photo detector in the non-image forming operation of the image forming apparatus based on the updated initial minimum voltage value.

7. The method of claim 1, wherein the determining of the state of the laser scanning device in the image forming apparatus based on the result of comparing the first minimum voltage value to the initial minimum voltage value comprises:
determining that the laser scanning device has a defect when the first minimum voltage value is greater than a minimum control voltage value within a control voltage range of the laser light emitter set to form a certain image in the image forming apparatus; and
determining that the laser scanning device has a defect when the first minimum voltage value is not greater than the minimum control voltage value and a difference value between the first minimum voltage value and the initial minimum voltage value is greater than or equal to a threshold value.

8. The method of claim 1, wherein the determining of the first minimum voltage value comprises:
applying a minimum voltage value corresponding to the initial minimum voltage value to the laser light emitter and determining whether the synchronization signal is detected by the photo detector; and
determining the first minimum voltage value at which the synchronization signal is detected by the photo detector while adjusting a voltage value applied to the laser light emitter when the synchronization signal is not detected.

9. The method of claim 1, wherein, when the image forming apparatus is a color image forming apparatus, the determining of the state of the laser scanning device in the image forming apparatus comprises determining the state of the laser scanning device in the image forming apparatus based on a result of comparing a minimum voltage value to an initial minimum voltage value for a laser light emitter of each of a plurality of colors.

10. A non-transitory computer-readable storage medium storing instructions executable by a processor, the non-transitory computer-readable storage medium comprising:
instructions for setting an initial minimum voltage value of a laser light emitter at which a synchronization signal of a laser beam is detected by a photo detector;
instructions for determining a first minimum voltage value of the laser light emitter at which the synchronization signal is detected by the photo detector in a non-image forming operation of an image forming apparatus;
instructions for determining a state of a laser scanning device in the image forming apparatus based on a result of comparing the first minimum voltage value to the initial minimum voltage value; and
instructions for outputting a result of the determining of the state of the laser scanning device.

11. An image forming apparatus comprising:
a laser scanning device comprising a laser light emitter to irradiate a laser beam used in an image forming operation and a photo detector to detect a synchronization signal of a laser beam;
a communication device;
a user interface device;
a processor; and
a memory storing instructions executable by the processor,
wherein the processor executes the instructions to:
set an initial minimum voltage value of a laser light emitter at which the synchronization signal is detected by the photo detector;
determine a first minimum voltage value of the laser light emitter at which the synchronization signal is detected by the photo detector in a non-image forming operation;
determine a state of the laser scanning device based on a result of comparing the first minimum voltage value to the initial minimum voltage value; and
output a result of the determining of the state of the laser scanning device through the user interface device.

12. The image forming apparatus of claim 11, wherein the processor executes the instructions to:
determine a difference value between the first minimum voltage value and the initial minimum voltage value; and
determine that the laser scanning device has a defect when the difference value is greater than or equal to a threshold value.

13. The image forming apparatus of claim 12, wherein the processor executes the instructions to periodically monitor a minimum voltage value of the laser light emitter at which the synchronization signal is detected by the photo detector in a non-image forming operation of the image forming apparatus when the difference value is less than the threshold value.

14. The image forming apparatus of claim 12, wherein the processor executes the instructions to:
receive a user input to continue using the image forming apparatus when it is determined that the laser scanning device has a defect;
update the initial minimum voltage value as a sum of the first minimum voltage value and the threshold value; and
perform a first image forming operation with an adjusted image forming density according to a first image forming operation command for the image forming apparatus by adjusting a voltage applied to an organic photo conductor (OPC) drum.

15. The image forming apparatus of claim 11, wherein the processor executes the instructions to:
determine that the laser scanning device has a defect when the first minimum voltage value is greater than a minimum control voltage value within a control voltage range of the laser light emitter set to form a certain image in the image forming apparatus; and
determine that the laser scanning device has a defect when the first minimum voltage value is not greater than the minimum control voltage value and a difference value between the first minimum voltage value and the initial minimum voltage value is greater than or equal to a threshold value.
